(19) United States
(12) Patent Application Publication
(10) Pub. No.: US 2022/0036662 A1
(43) Pub. Date: Feb. 3, 2022

(54) SERVER, NON-TRANSITORY COMPUTER READABLE MEDIUM, AND CONTROL METHOD

(71) Applicant: Toyota Jidosha Kabushiki Kaisha, Toyota-shi Aichi-ken (JP)

(72) Inventors: Yusuke Nakade, Nagoya-shi Aichi-ken (JP); Miho Otsuka, Nagoya-shi Aichi-ken (JP); Shunsuke Tanimori, Nagoya-shi Aichi-ken (JP); Hirokazu Kano, Nagoya-shi Aichi-ken (JP); Scott R. Meyer, Allen, TX (US); Michael C. Edwards, McKinney, TX (US)

(21) Appl. No.: 17/388,575

(22) Filed: Jul. 29, 2021

(30) Foreign Application Priority Data
Aug. 3, 2020 (JP) 2020-132046

(51) Int. Cl. G07B 15/02; G08G 1/14; G06Q 10/02; G07C 9/10

(52) U.S. Cl. CPC G07B 15/02; G08G 1/142; G07C 9/10; G06Q 10/02; G08G 1/146

(57) ABSTRACT

A server is communicably connected to a movement impeding means provided at a parking space. The server includes a controller configured to: upon detecting reservation of the parking space, operate the movement impeding means to prevent other vehicles from parking in the parking space; upon detecting approach of a reserving vehicle that is a subject of the reservation of the parking space, cancel operation of the movement impeding means to enable the reserving vehicle to park in the parking space; and upon detecting parking of the reserving vehicle in the parking space, operate the movement impeding means.

### CROSS-REFERENCE TO RELATED APPLICATION

This application claims priority to Japanese Patent Application No. 2020-132046 (filed on Aug. 3, 2020), the entire contents of which are incorporated herein by reference.

### TECHNICAL FIELD

The present disclosure relates to a server, a program, and a control method.

### BACKGROUND

A parking facility in which, upon detection of parking of a vehicle by a parking detection means, a movement impeding plate driving mechanism operates to immovably lock the wheels of the parking vehicle, is known (for example, Patent Literature [PTL] 1). The parking facility cancels operation of the movement impeding plate upon payment of a predetermined fee at a payment collection machine. The parking facility emits a warning to a general vehicle attempting to park during a reserved time slot.

### CITATION LIST

### Patent Literature

PTL 1: JP H09-235901 A

### SUMMARY

When a warning is given to a vehicle attempting to park within a reserved time slot, the warning may not be delivered or may be ignored. In this case, because there is a risk that the vehicle parks in the parking facility within the reserved time slot, there is room for improvement in its effectiveness.

It would be helpful to provide a server, a program, and a control method that are capable of securing a reserved parking space for a reserving vehicle.

A server according to an embodiment of the present disclosure is communicably connected to a movement impeding means provided at a parking space, the server including a controller configured to:

upon detecting reservation of the parking space, operate the movement impeding means to prevent other vehicles from parking in the parking space;

upon detecting approach of a reserving vehicle that is a subject of the reservation of the parking space, cancel operation of the movement impeding means to enable the reserving vehicle to park in the parking space; and

upon detecting parking of the reserving vehicle in the parking space, operate the movement impeding means.

A program according to an embodiment of the present disclosure is configured to cause a computer, as a server communicably connected to a movement impeding means provided at a parking space, to execute operations, the operations including:

upon detecting reservation of the parking space, operating the movement impeding means to prevent other vehicles from parking in the parking space;

upon detecting approach of a reserving vehicle that is a subject of the reservation of the parking space, cancelling operation of the movement impeding means to enable the reserving vehicle to park in the parking space; and

upon detecting parking of the reserving vehicle in the parking space, operating the movement impeding means.

A control method according to an embodiment of the present disclosure is performed by a server communicably connected to a movement impeding means provided at a parking space, the control method including:

upon detecting reservation of the parking space, operating the movement impeding means to prevent other vehicles from parking in the parking space;

upon detecting approach of a reserving vehicle that is a subject of the reservation of the parking space, cancelling operation of the movement impeding means to enable the reserving vehicle to park in the parking space; and

upon detecting parking of the reserving vehicle in the parking space, operating the movement impeding means.

The server, the program, and the control method according to embodiments of the present disclosure can secure the reserved parking space for the reserving vehicle.

### BRIEF DESCRIPTION OF THE DRAWINGS

In the accompanying drawings:

FIG. 1 is a schematic diagram of an information processing system;

FIG. 2 is a block diagram illustrating a configuration of a vehicle;

FIG. 3 is a block diagram illustrating a configuration of a movement impeding means;

FIG. 4 is a block diagram illustrating a configuration of a server;

FIG. 5 is a diagram illustrating a data structure of a reservation DB (database);

FIG. 6 is a diagram illustrating a first state of the movement impeding means at the time of parking;

FIG. 7 is a diagram illustrating a second state of the movement impeding means at the time of parking;

FIG. 8 is a diagram illustrating a third state of the movement impeding means at the time of parking; and

FIG. 9 is a flowchart illustrating operation of the server.

### DETAILED DESCRIPTION

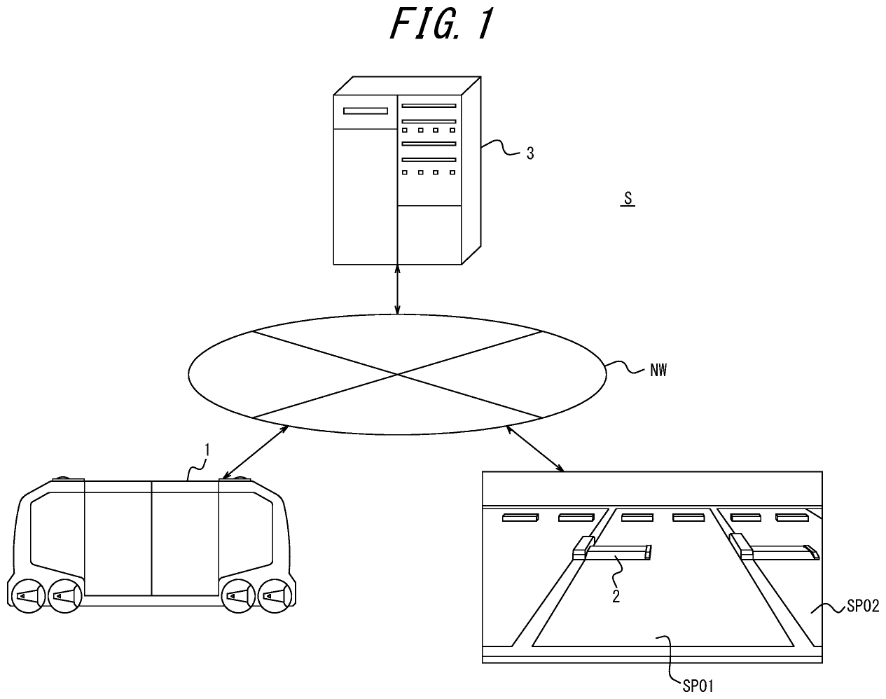

FIG. 1 is a schematic diagram of an information processing system S according to an embodiment. The information processing system S includes a vehicle 1, a movement impeding means 2, and a server 3, which are communicably connected to each other via a network NW. The movement impeding means 2 is provided in a parking space SP01 in a parking lot. For convenience of explanation, FIG. 1 illustrates one of each of the vehicle 1, the movement impeding means 2, and the server 3. However, the number of vehicles 1, the number of the movement impeding means 2, and the number of servers 3 are not limited to one. For example, the processing executed by the server 3 of the present embodiment may be executed by a plurality of distributed servers 3. The network NW includes, for example, a mobile communication network and the Internet.

An outline of processing that is executed by the server 3 according to the present embodiment will be described. The server 3 is configured to: upon detecting reservation of the parking space, operate the movement impeding means 2 to prevent other vehicles from parking in the parking space; upon detecting approach of the reserving vehicle 1 that is the subject of the reservation, cancel operation of the movement impeding means 2 to enable the reserving vehicle 1 to park in the parking space; and upon detecting parking of the reserving vehicle 1 in the parking space, operate the movement impeding means 2. According to this configuration, the server 3 can prevent parking by other vehicles in the parking space, thereby securing the parking space for the reserving vehicle 1.

The vehicle 1 includes, for example, any type of automobile such as a gasoline vehicle, a diesel vehicle, an HV, a PHV, an EV, or an FCV. The term “HV” is an abbreviation of hybrid vehicle. The term “PHV” is an abbreviation of plug-in hybrid vehicle. The term “EV” is an abbreviation of electric vehicle. The term “FCV” is an abbreviation of fuel cell vehicle. The operation of the vehicle 1 may be automated at any level. The automation level is, for example, any one of Level 1 to Level 5 according to the level classification defined by the SAE. The name “SAE” is an abbreviation of Society of Automotive Engineers. The vehicle 1 may be a MaaS-dedicated vehicle. The term “MaaS” is an abbreviation of Mobility as a Service. As an alternative example, the vehicle 1 may be driven by a driver.

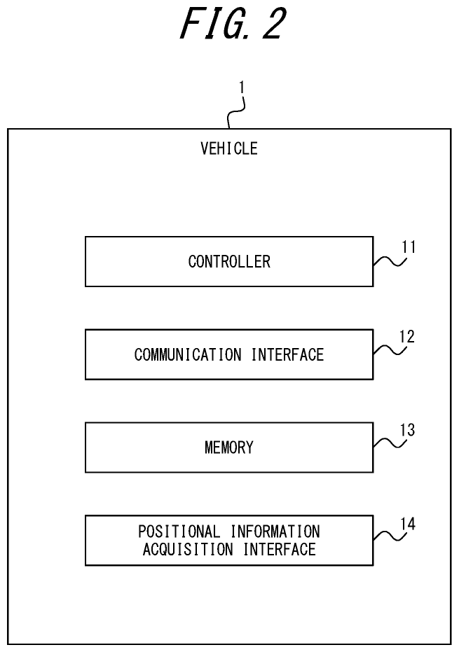

An internal configuration of the vehicle 1 is described in detail with reference to FIG. 2.

The vehicle 1 includes a controller 11, a communication interface 12, a memory 13, and a positional information acquisition interface 14. The components of the vehicle 1 are communicably connected to each other via an in-vehicle network such as a CAN (Controller Area Network) or a dedicated line, for example.

The controller 11 includes, for example, one or more general-purpose processors including a Central Processing Unit (CPU) or a Micro Processing Unit (MPU). The controller 11 may include one or more dedicated processors that are dedicated to specific processing. The controller 11 may include one or more dedicated circuits instead of the processor. Examples of dedicated circuits may include a Field-Programmable Gate Array (FPGA) and an Application Specific Integrated Circuit (ASIC). For example, the controller 11 may include an electronic control unit (ECU).

The communication interface 12 includes, for connecting to the network NW, one or more communication modules that conform to wired or wireless Local Area Network (LAN) standards. The communication interface 12 may include one or more modules conforming to mobile communication standards including the 4th Generation (4G) standard or the 5th Generation (5G) standard. The communication interface 12 may include one or more communication modules conforming to short-range wireless communication standards or specifications, including Bluetooth (Bluetooth is a registered trademark in Japan, other countries, or both), AirDrop (AirDrop is a registered trademark in Japan, other countries, or both), IrDA, ZigBee (ZigBee is a registered trademark in Japan, other countries, or both), Felica (Felica is a registered trademark in Japan, other countries, or both), or RFID. The communication interface 12 is configured to transmit and receive any appropriate information via the network NW. The any appropriate information includes, for example, positional information acquired through the Global Positioning System (GPS).

The memory 13 may be, but is not limited to, a semiconductor memory, a magnetic memory, or an optical memory. The memory 13 may function as, for example, a main memory, an auxiliary memory, or a cache memory. The memory 13 may store information resulting from analysis or processing performed by the controller 11. The memory 13 may store various information and the like related to the operation or control of the vehicle 1. The memory 13 may include a system program, an application program, embedded software, and the like.

The positional information acquisition interface 14 includes at least one GNSS receiver. The term “GNSS” is an abbreviation of global navigation satellite system. Examples of GNSS include GPS, QZSS, BeiDou, GLONASS, GLONASS, and Galileo. The term “GPS” is an abbreviation of Global Positioning System. The term “QZSS” is an abbreviation of Quasi-Zenith Satellite System. QZSS satellites are called quasi-zenith satellites. The term “GLONASS” is an abbreviation of Global Navigation Satellite System. The positional information acquisition interface 14 measures a position of the vehicle 1.

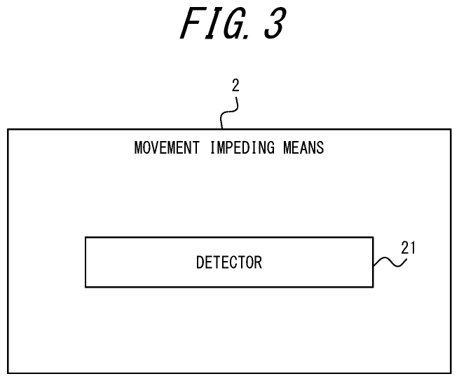

An internal configuration of the movement impeding means 2 will be described in detail with reference to FIG. 3.

The movement impeding means 2 may be a movement impeding plate as illustrated in FIG. 1. As an alternative example, the movement impeding means 2 may be a means for physically locking a wheel of the vehicle 1 or physically blocking movement of the wheel. As another alternative example, the movement impeding means 2 may be a virtual geographical boundary, or a geo-fence.

The movement impeding means 2 includes a detector 21. The detector 21 can identify a specific object. For example, the detector 21 may include a camera. The detector 21 analyzes a captured image to detect approach of an object within a predetermined distance. As an alternative example, the detector 21 may include a proximity sensor or a short-range wireless communication means. The detector 21 detects approach of an object within a predetermined distance using the proximity sensor or the short-range wireless communication means.

The server 3 may assist a provider in providing a vehicle dispatch service. The server 3 may be, for example, installed in a facility dedicated to the vehicle dispatch provider or in a shared facility that includes a data center. The server 3 may control operation of the vehicle 1 and operation of the movement impeding means 2. As an alternative example, the server 3 may be mounted in the vehicle 1.

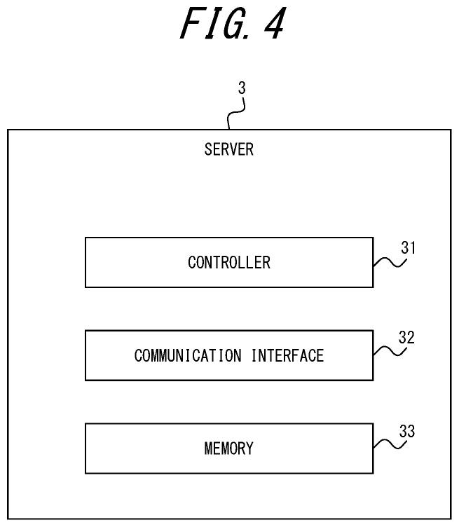

An internal configuration of the server 3 is described in detail with reference to FIG. 4.

The server 3 includes a controller 31, a communication interface 32, and a memory 33. The components of the server 3 are communicably connected to one another via, for example, a dedicated line.

In the present embodiment, hardware components of the controller 31, the communication interface 32, and the memory 33 of the server 3 are the same as the hardware components of the controller 11, the communication interface 12, and the memory 13 of the vehicle 1. Therefore, a description thereof is omitted here.

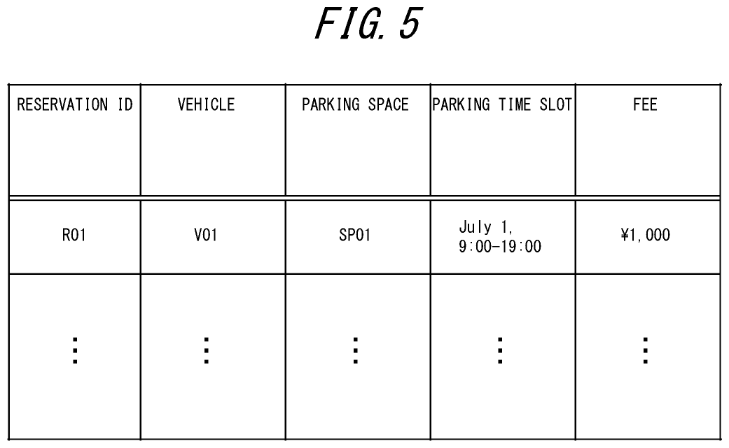

The memory 33 includes a reservation DB as illustrated in FIG. 5. In the reservation DB, an identifier for a vehicle that will park (corresponding to “VEHICLE” illustrated in FIG. 5), a parking space for parking (corresponding to “PARKING SPACE” illustrated in FIG. 5), a parking time slot for parking (corresponding to “PARKING TIME SLOT” illustrated in FIG. 5), and a parking fee (corresponding to “FEE” illustrated in FIG. 5) are stored in association with a reservation ID. As an alternative example, the reservation DB may be stored in a storage device external to the server 3 and accessed from the server 3.

Hereinafter, processing executed in the information processing system S according to the present embodiment will be described in detail. Here, as an example, a situation in which a user in the vehicle 1, using an application or another communication service, reserves a parking space for parking of the vehicle 1 will be described.

The controller 31 of the server 3 receives a parking reservation from a terminal of the user or from the vehicle 1. Here, as illustrated in FIG. 5, the parking reservation includes an identifier for the vehicle 1 (corresponding to “V01”), an identifier for a parking space in which the vehicle 1 is to park (corresponding to “SP01”), information indicating a parking time slot for parking (corresponding to “July 1, 9:00-19:00”) and information indicating a parking fee (corresponding to “¥1,000”). The controller 31 of the server 3 stores the parking reservation in the reservation DB as illustrated in FIG. 5. The controller 31 of the server 3, upon receiving the parking reservation, reserves a parking space in accordance with the reservation details.

Additionally, the controller 31 of the server 3, when accepting reservation of the parking space SP01, may propose reservation of one or more neighboring parking spaces (see a parking space SP02 illustrated in FIG. 1) in addition to the reservation of the parking space SP01. This proposal may be executed when a predetermined plan (e.g., loading and unloading, or repairing) is registered in a schedule of the user within the parking time slot. The controller 31 of the server 3 executes an additional reservation in accordance with a user request.

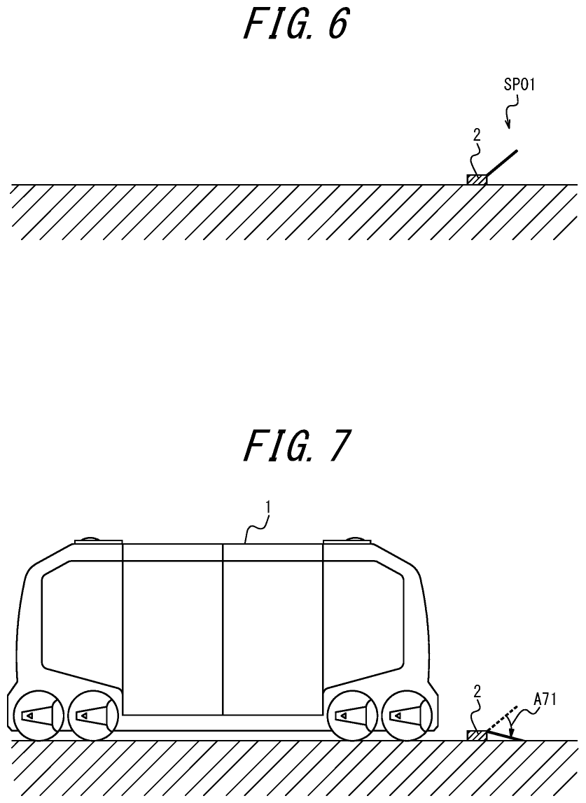

The controller 31 of the server 3, upon detecting reservation of the parking space SP01, operates the movement impeding means in the parking space SP01 so that other vehicles, other than the vehicle 1, cannot park in the parking space SP01. Specifically, as illustrated in FIG. 6, the controller 31 of the server 3 raises the movement impeding means 2 substantially upward in a vertical direction, so that other vehicles cannot park in the parking space SP01. As an alternative example, when the movement impeding means 2 is a geo-fence, the controller 31 of the server 3 operates the geo-fence to prevent other vehicles from entering an area defined by the geo-fence. For example, the controller 31 of the server 3 may warn a vehicle attempting to enter the area defined by the geo-fence. As an alternative example, the controller 31 of the server 3 may prevent other vehicles from entering the area defined by the geo-fence.

As an alternative example, the controller 31 of the server 3 may, upon detecting reservation of the parking space SP01, calculate a time difference from the current time to a start time of the reserved parking time slot. The controller 31 of the server 3, when the time difference is less than a predetermined value, may operate the movement impeding means 2 to prevent vehicles from parking in the parking space SP01.

The controller 31 of the server 3 determines whether the vehicle 1 is approaching the parking space SP01. Specifically, the controller 31 of the server 3, using the detector 21 of the movement impeding means 2, may determine whether the vehicle 1 is in the vicinity (e.g., within a predetermined distance) of the parking space SP01. The controller 31 of the server 3, upon detecting approach of a vehicle different from the vehicle 1 to the parking space SP01, may notify the vehicle that parking in the parking space SP01 is not possible. This notification may be made by a sound through a speaker of the approaching vehicle or a speaker of the movement impeding means 2. As an alternative example, the controller 31 of the server 3, from the positional information for the vehicle 1 acquired by the positional information acquisition interface 14, may determine whether the vehicle 1 is in the vicinity of the parking space SP01.

The controller 31 of the server 3, upon determining that the vehicle 1 is approaching the parking space SP01, cancels operation of the movement impeding means 2 as illustrated in FIG. 7. In this situation, the movement impeding means 2 moves in the direction of arrow A71. The vehicle 1 can park in the parking space SP01.

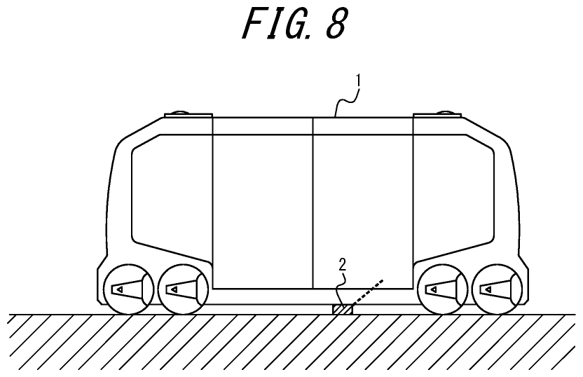

Upon cancellation of operation of the movement impeding means 2, the vehicle 1 parks in the parking space SP01 as illustrated in FIG. 8. The controller 31 of the server 3, upon detecting parking of the vehicle 1 in the parking space SP01, operates the movement impeding means 2 to physically prevent the vehicle 1 from leaving the parking space SP01. The controller 31 of the server 3 may notify the vehicle 1 that a parking fee will be incurred if parking continues past the reserved parking time slot. This notification may be made by a sound through the speaker of vehicle 1 or the speaker or the movement impeding means 2.

The controller 31 of the server 3, upon detecting payment of the parking fee, cancels operation of the movement impeding means 2 to enable the vehicle 1 to leave the parking space SP01.

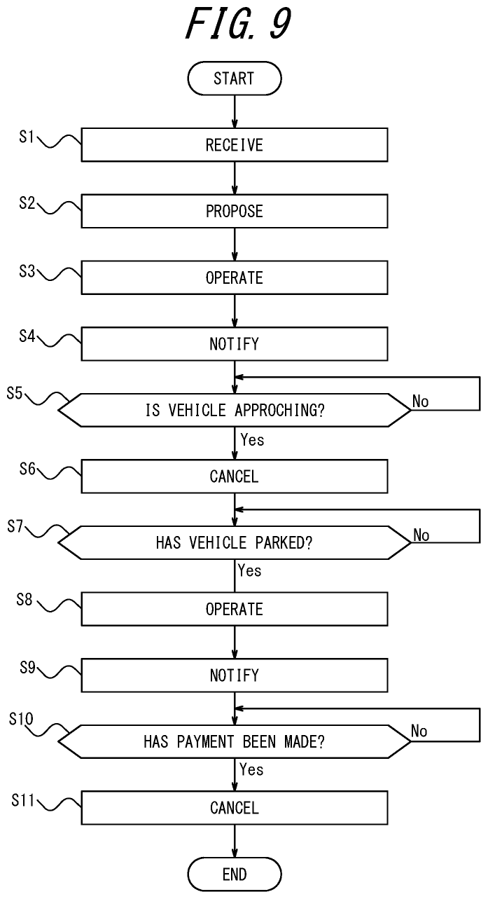

A control method performed by the server 3 will be described with reference to FIG. 9.

In Step S1, the controller 31 of the server 3 receives the parking reservation.

In Step S2, the controller 31 of the server 3 proposes reservation of neighboring parking spaces in addition to the parking space SP01 reserved by the user.

In Step S3, the controller 31 of the server 3 operates the movement impeding means 2 to prevent other vehicles from parking in the parking space SP01.

In Step S4, the controller 31 of the server 3, upon detecting approach of a vehicle different from the vehicle 1 to the parking space SP01 during the reserved parking time slot, notifies the other vehicle that parking is not possible.

In Step S5, the controller 31 of the server 3 determines whether the vehicle 1 is approaching. If the result of the determination is “No” in Step S5, the controller 31 of the server 3 executes Step S5 again.

If the result of the determination is “Yes” in Step S5, the controller 31 of the server 3 cancels, in Step S6, operation of the movement impeding means 2. As a result, the vehicle 1 can park in the parking space SP01.

In Step S7, the controller 31 of the server 3 determines whether the vehicle 1 has parked. If the result of the determination is “No” in Step S7, the controller 31 of the server 3 executes Step S7 again.

If the result of the determination is “Yes” in Step S7, the controller 31 of the server 3 operates, in Step S8, the movement impeding means 2 to prevent the vehicle 1 from leaving the parking space SP01.

In Step S9, the controller 31 of the server 3 notifies the vehicle 1 that a parking fee will be incurred if parking continues past the parking time slot.

In Step S10, the controller 31 of the server 3 determines whether payment of the parking fee has been made. If the result of the determination is “No” in Step S10, the controller 31 of the server 3 executes Step S10 again.

If the result of the determination is “Yes” in Step S10, the controller 31 of the server 3 cancels, in Step S11, operation of the movement impeding means 2. In this situation, the vehicle 1 can leave the parking space SP01.

As has been described, according to the present embodiment, the controller 31 of the server 3 is configured to: upon detecting reservation of the parking space, operate the movement impeding means 2 to prevent other vehicles from parking in the parking space; upon detecting approach of the reserving vehicle 1 that is a subject of the reservation, cancel operation of the movement impeding means 2 to enable the reserving vehicle 1 to park in the parking space; and upon detecting parking of the reserving vehicle 1 in the parking space, operate the movement impeding means 2. According to this configuration, the controller 31 of the server 3 can prevent parking by other vehicles in the parking space, thereby securing the parking space for the reserving vehicle 1.

Moreover, according to the present embodiment, the movement impeding means 2 includes a movement impeding plate or is a geo-fence. According to this configuration, the controller 31 of the server 3 can enhance effectiveness by preventing parking by other vehicles in the parking space.

Moreover, according to the present embodiment, the controller 31, upon detecting approach of another vehicle that is different from the reserving vehicle 1 during a reserved parking time slot, notifies the other vehicle that parking is not possible. According to this configuration, the controller 31 of the server 3 can more effectively prevent parking by other vehicles in the parking space.

Moreover, according to the present embodiment, the controller 31 notifies the reserving vehicle 1 that a parking fee will be incurred if parking continues past the reserved parking time slot. According to this configuration, the controller 31 of the server 3 can prevent parking by the reserving vehicle 1 past the reserved parking time slot, thereby reducing restrictions on parking by other vehicles. Thus, the overall convenience is improved.

Moreover, according to the present embodiment, the controller 31, upon detecting reservation of the parking space, calculates the time difference from the current time to the start time of the reserved parking time slot, and when the time difference is less than a predetermined value, operates the movement impeding means 2 to prevent other vehicles from parking in the parking space. Thus, the controller 31 of the server 3 can reduce parking by the other vehicles when the parking time slot for the reserving vehicle 1 is approaching, thereby securing the parking space for the reserving vehicle 1 with more certainty.

Moreover, according to the present embodiment, the controller 31 proposes reservation of one or more neighboring parking spaces of the parking space in addition to the parking space. According to this configuration, the controller 31 of the server 3 can assist work (e.g. loading and unloading, or repairing) around the reserved parking space, thereby increasing convenience.

Moreover, according to the present embodiment, the movement impeding means 2 includes a detector 21. The controller 31 detects approach of the reserving vehicle 1 to the parking space using the detector 21. According to this configuration, the controller 31 of the server 3 can determine with higher accuracy whether the vehicle 1 is approaching the parking space SP01.

While the present disclosure has been described with reference to the drawings and examples, it should be noted that various modifications and revisions may be implemented by those skilled in the art based on the present disclosure. Other modifications can be made without departing from the spirit of the present disclosure. For example, functions or the like included in each means or each step can be rearranged without logical inconsistency, and a plurality of means or steps can be combined together or divided.

For example, in the above embodiment, a program that executes all or some of the functions or processing of the server 3 may be recorded on a computer readable recording medium. The computer readable recording medium includes a non-transitory computer readable medium and may be a magnetic recording apparatus, an optical disc, a magneto-optical recording medium, or a semiconductor memory. The program is distributed, for example, by selling, transferring, or lending a portable recording medium such as a Digital Versatile Disc (DVD) or a Compact Disc Read Only Memory (CD-ROM) on which the program is recorded. The program may also be distributed by storing the program in a storage of any server and transmitting the program from any server to another computer. The program may also be provided as a program product. The present disclosure may also be implemented as a program that can be executed by a processor.

1. A server communicably connected to a movement impeding means provided at a parking space, the server comprising a controller configured to:
upon detecting reservation of the parking space, operate the movement impeding means to prevent other vehicles from parking in the parking space;
upon detecting approach of a reserving vehicle that is a subject of the reservation of the parking space, cancel operation of the movement impeding means to enable the reserving vehicle to park in the parking space; and
upon detecting parking of the reserving vehicle in the parking space, operate the movement impeding means.

2. The server according to claim 1, wherein the movement impeding means comprises a movement impeding plate or is a geo-fence.

3. The server according to claim 1, wherein the controller is configured to, upon detecting approach of another vehicle that is different from the reserving vehicle to the parking space during a parking time slot reserved by the reservation, notify the another vehicle that parking is not possible.

4. The server according to claim 1, wherein the controller is configured to notify the reserving vehicle that, if parking continues past a parking time slot reserved by the reservation, a parking fee will be incurred.

5. The server according to claim 1, wherein the controller is configured to:
upon detecting reservation of the parking space, calculate a time difference from a current time to a start time of a parking time slot reserved by the reservation, and
when the time difference is less than a predetermined value, operate the movement impeding means to prevent other vehicles from parking in the parking space.

6. The server according to claim 1, wherein the controller is configured to propose reservation of one or more neighboring parking spaces of the parking space in addition to the parking space.

7. The server according to claim 1, wherein
the movement impeding means comprises a detector, and
the controller is configured to detect, using the detector, approach of the reserving vehicle to the parking space.

8. A non-transitory computer readable medium storing a program configured to cause a computer, as a server communicably connected to a movement impeding means provided at a parking space, to execute operations, the operations comprising:
upon detecting reservation of the parking space, operating the movement impeding means to prevent other vehicles from parking in the parking space;
upon detecting approach of a reserving vehicle that is a subject of the reservation of the parking space, cancelling operation of the movement impeding means to enable the reserving vehicle to park in the parking space; and
upon detecting parking of the reserving vehicle in the parking space, operating the movement impeding means.

9. The non-transitory computer readable medium according to claim 8, wherein the movement impeding means comprises a movement impeding plate or is a geo-fence.

10. The non-transitory computer readable medium according to claim 8, wherein the program is configured to cause the computer to further execute, upon detecting approach of another vehicle that is different from the reserving vehicle to the parking space during a parking time slot reserved by the reservation, notifying the another vehicle that parking is not possible.

11. The non-transitory computer readable medium according to claim 8, wherein the program is configured to cause the computer to further execute notifying the reserving vehicle that, if parking continues past a parking time slot reserved by the reservation, a parking fee will be incurred.

12. The non-transitory computer readable medium according to claim 8, wherein the program is configured to cause the computer to further execute:
upon detecting reservation of the parking space, calculating a time difference from a current time to a start time of a parking time slot reserved by the reservation, and
when the time difference is less than a predetermined value, operating the movement impeding means to prevent other vehicles from parking in the parking space.

13. The non-transitory computer readable medium according to claim 8, wherein the program is configured to cause the computer to further execute proposing reservation of one or more neighboring parking spaces of the parking space in addition to the parking space.

14. The non-transitory computer readable medium according to claim 8, wherein
the movement impeding means comprises a detector, and
the program is configured to cause the computer to further execute detecting, using the detector, approach of the reserving vehicle to the parking space.

15. A control method performed by a server communicably connected to a movement impeding means provided at a parking space, the control method comprising:
upon detecting reservation of the parking space, operating the movement impeding means to prevent other vehicles from parking in the parking space;
upon detecting approach of a reserving vehicle that is a subject of the reservation of the parking space, cancelling operation of the movement impeding means to enable the reserving vehicle to park in the parking space; and
upon detecting parking of the reserving vehicle in the parking space, operating the movement impeding means.

16. The control method according to claim 15, wherein the movement impeding means comprises a movement impeding plate or is a geo-fence.

17. The control method according to claim 15, further comprising, upon detecting approach of another vehicle that is different from the reserving vehicle to the parking space during a parking time slot reserved by the reservation, notifying the another vehicle that parking is not possible.

18. The control method according to claim 15, further comprising, notifying the reserving vehicle that, if parking continues past a parking time slot reserved by the reservation, a parking fee will be incurred.

19. The control method according to claim 15, further comprising:
upon detecting reservation of the parking space, calculating a time difference from a current time to a start time of a parking time slot reserved by the reservation, and
when the time difference is less than a predetermined value, operating the movement impeding means to prevent other vehicles from parking in the parking space.

20. The control method according to claim 15, further comprising, proposing reservation of one or more neighboring parking spaces of the parking space in addition to the parking space.
